(19) United States
(12) Patent Application Publication
(10) Pub. No.: US 2008/0136942 A1
(43) Pub. Date: Jun. 12, 2008

(54) IMAGE SENSOR EQUIPPED PHOTOGRAPHING APPARATUS AND PICTURE PHOTOGRAPHING METHOD

(75) Inventors: Sung Jae YOON, Gumi-si (KR); Dong Han KANG, Daegu Metropolitan City (KR); Jae Gwan SHIN, Daegu Metropolitan City (KR); Chang Min OH, Daegu Metropolitan City (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/943,425

(22) Filed: Nov. 20, 2007

(30) Foreign Application Priority Data
Dec. 6, 2006 (KR) 10-2006-0123024

(51) Int. Cl. H04N 5/76

(52) U.S. Cl. 348/231.99; 348/E05.024

(57) ABSTRACT

An image sensor equipped photographing apparatus and a picture photographing method thereof are provided. The picture photographing method includes generating image data from an image signal output by an image sensor, storing the image data, outputting the image data as a preview image data, inputting a photographing signal to process the image data into a photographed image, and photographing an image by transforming the preview image data into the photographed image. The picture photographing method and apparatus provide a photographed image at the moment a shutter key is pressed, thereby providing an accurate photographed image at the user's desired moment.

### CROSS-REFERENCE TO RELATED APPLICATION

This application claims priority from and the benefit of Korean Patent Application No. 10-2006-0123024, which is hereby incorporated by reference for all purposes as if fully set forth herein.

### BACKGROUND OF THE INVENTION

1. Field of the Invention

The present invention relates to a picture photographing method and an image sensor equipped photographing apparatus. Particularly, the present invention relates to an image sensor equipped photographing apparatus for providing a photographed image at the moment a photographing key is pressed and the picture photographing method thereof.

2. Discussion of the Background

An image sensor equipped photographing apparatus is one in which a processor controlling a camera delivers commands to an image sensor to capture a preview image. After receiving the commands, the image sensor is transformed from a preview mode into a snapshot mode and outputs a photographed image.

In a conventional photographing apparatus, shutter lag occurs due to the time interval between pressing a shutter key and capturing a photographed image. Generally, the shutter lag is approximately 0.3 seconds. Therefore, it is difficult to capture an image at the desired time. For example, if an object is moving quickly, the photographing may occur after the object has passed.

### SUMMARY OF THE INVENTION

The present invention provides an image sensor equipped photographing apparatus and a method thereof that may provide a photographed image at the moment the shutter key is pressed.

Additional features of the present invention will be set forth in part in the description which follows and, in part will be apparent from the description, or may be learned by practice of the present invention.

The present invention discloses a picture photographing method for an image sensor equipped photographing apparatus, including generating image data from an image signal output by the image sensor; storing the image data, outputting the image data as preview image data, receiving a photographing signal, and photographing, upon receiving the photographing signal, an image by transforming the preview image data into a photographed image.

The present invention also discloses an image sensor equipped photographing apparatus, including an image sensor to capture an image and output the image as an image signal, a signal processing unit to transform the image signal into image data, an image processing unit to transform the image data into screen data, a display unit to display the screen data, a preview image storage unit to store the image data for display as a preview image in the display unit, an input unit to receive a photographing signal; and a control unit to detect the photographing signal from the input unit and control processing of the image data stored in the preview image storage unit into a photographed image.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a photographing apparatus according to an exemplary embodiment of the present invention.

FIG. 2 is a diagram showing a configuration of a preview image storage unit of the photographing apparatus of FIG. 1.

FIG. 3 is a flow chart showing a picture photographing method according to an exemplary embodiment of the present invention.

FIG. 4 is a flow chart showing a procedure for storing and displaying previewed image data in the picture photographing method of FIG. 3.

FIG. 5 is a diagram showing a procedure for storing a previewed image in a picture photographing method according to an exemplary embodiment of the present invention.

FIG. 6 is a flow chart showing an image photographing procedure in the picture photographing method of FIG. 3.

FIG. 7 and FIG. 8 are diagrams showing the image photographing procedure of FIG. 6.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Hereinafter, in exemplary embodiments of the present invention, a “photographing mode” is a mode in which an image signal is displayed on the display unit after being acquired by an image sensor, and in which a still image may be captured by pressing a shutter key. A “preview” image is an image displayed as a moving picture converted from an image signal acquired by an image sensor so that a user can select an image for photographing using a shutter key. A “snap shot” is a still image captured by pressing a shutter key while displaying a preview image.

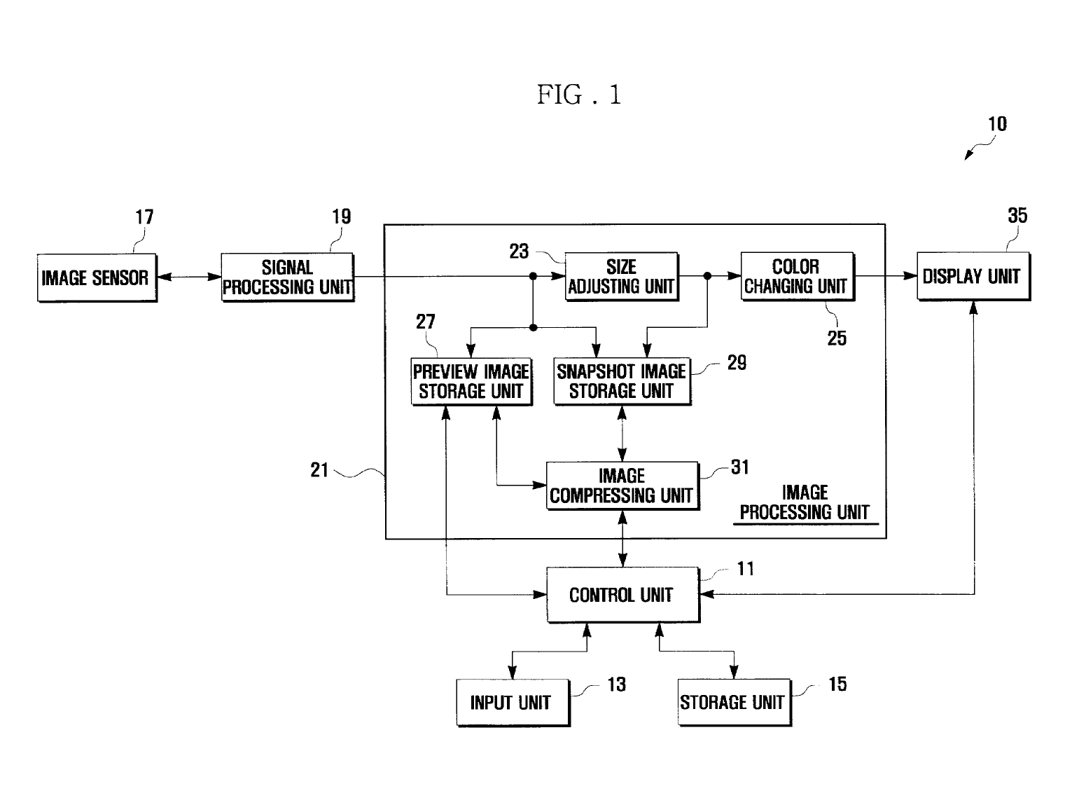

FIG. 1 is a block diagram showing a configuration of a photographing apparatus according to an exemplary embodiment of the present invention.

Referring to FIG. 1, a photographing apparatus 10 includes an image sensor 17, a signal processing unit 19, an image processing unit 21, an input unit 13, a display unit 35, a storage unit 15, and a control unit 11.

The image sensor 17 acquires an image signal of an object by processing an optical signal of the object into an electronic image signal. The image sensor 17 may include a Charge Coupled Device (CCD) sensor or Complementary Metal Oxide Semiconductor (CMOS) sensor.

The signal processing unit 19 processes the image signal output from the image sensor 17 into digital image data. The signal processing unit 19 may be a Digital Signal Processor (DSP).

The image processing unit 21 processes the digital image data output from the signal processing unit 19 into screen data for display on the display unit 35. The image processing unit 21 interfaces with the signal processing unit 19 and the display unit 35. The image processing unit 21 includes a size adjusting unit 23, a color changing unit 25, an image compressing unit 31, a snapshot image storage unit 29, and a preview image storage unit 27. The image processing unit 21 processes the image to interface with the display unit 35, and revises the image by adjusting image characteristics, such as an illumination and color tone. The snapshot image storage unit 29 and the preview image storage unit 27 may include a buffer.

The size adjusting unit 23 scales the digital image output from the signal processing unit 19 to reduce the image size and crops the image by cutting off edges of the image to meet the standard size of the display unit 35. The color changing unit 25 transforms image data output from the signal processing unit 19 into a required format for the display unit 35. For example, the size adjusting unit 23 may transform image data having a size of 640×480 into a size of 176×220 or a size of 128×112, and may transform a size of 1280×960 into a size of 176×220 or 128×112. The color changing unit 25 transforms an image data from a YUV format into an RGB format. The image compressing unit 31 compresses and decompresses image signals input from the signal processing unit 19 in JPEG format. The image processing unit 21 performs an I2C interface in order to establish a path of control data from the control unit 11.

The snapshot image storage unit 29 buffers high-definition image data input from the signal processing unit 19 after processing the image data received from the image sensor 17 when the shutter key was pressed. The snapshot image storage unit 29 functions as a line buffer by buffering in line. The preview image storage unit 27 buffers image data in frames input from the signal processing unit 19 after processing image data received from the image sensor 17 to provide a preview image. The preview image storage unit 27 and the snapshot image storage unit 29 store the image data in temporary stored image buffers. The preview image storage unit 27 and the snapshot image storage unit 29 may be included in the image processing unit 21. Alternatively, the preview image storage unit 27 and the snapshot image storage unit 29 may be included in the storage unit 15.

The display unit 35 displays screen data output from the image processing unit 21 and user data output from the control unit 11. The display unit 35 may be a displaying apparatus such as a Liquid Crystal Display (LCD), an Organic Light Emitting Diode (OLED) display, and a Plasma Display Panel (PDP). The display unit 35 may display operation information, user key manipulation, and the operation result of the photographing apparatus 10. The display unit 35 also may display a preview image, a photographed image, and a stored image output from the photographing apparatus 10.

The input unit 13 has function keys to set functions and keys to input number and character information, and outputs command signals related to the overall operation of the photographing apparatus 10. The input unit 13 includes a key pad, a touch screen, and a touch pad. The input unit 13 includes a photographing mode key for entry into the photographing mode and a shutter key for photographing in the photographing mode.

The storage unit 15 stores programs and data to control the operation of the photographing apparatus 10 and temporarily stores data produced during the operation of the photographing apparatus 10. The storage unit 15 stores compressed image data from the image processing unit 21.

The control unit 11 sets up a photographing mode according to a signal from the input unit 13 and outputs a preview screen or a photographing screen to the display unit 35. The control unit 11 may display a preview screen or a snapshot screen as a photographed picture on the display unit 35 and confirms the user's selection of the preview screen or the snapshot screen. The control unit 11 processes a photographed image from a preview image stored in the preview image storage unit 27 prior to the moment the shutter key is pressed confirming the preview screen. The control unit 11 processes a photographed image from a snapshot image generated when the shutter key was pressed by confirming the snapshot screen. The control unit 11 controls the overall operation of the photographing apparatus 10.

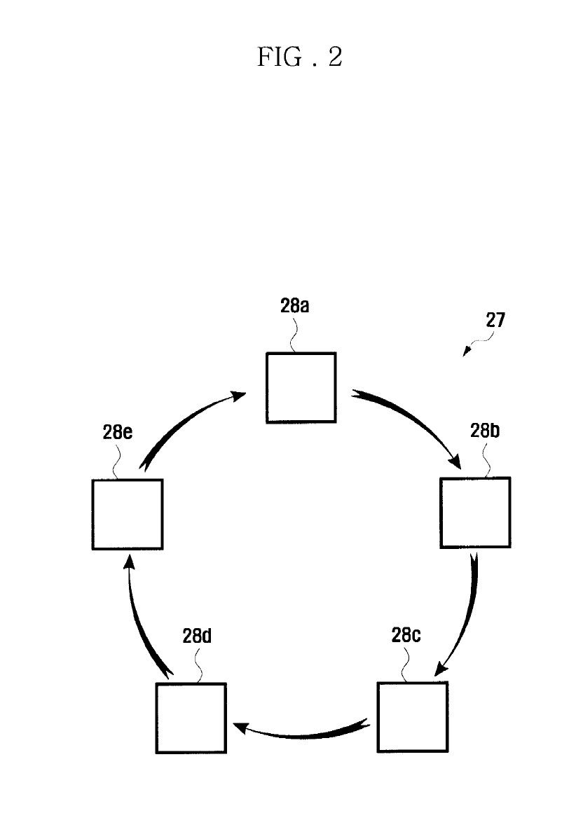

FIG. 2 is a diagram showing a configuration of the preview image storage unit 27 of the photographing apparatus.

In accordance with an exemplary embodiment of the present invention, the preview image storage unit 27 in the photographing apparatus 10 may include a circular queue buffer having plural storage areas 28a, 28b, 28c, 28d, and 28e, as shown in FIG. 2. The circular queue buffer including plural storage areas 28a, 28b, 28c, 28d, and 28e stores image data in the order of occurrence in individual storage areas from a stand-by array. The plural storage areas 28a, 28b, 28c, 28d, and 28e may include an independent buffer format. The number of storage areas can increase or decrease depending on the product specification and other factors, as described below.

After image data is stored in every storage area, new preview image data is placed in the storage area of the first stored preview image data to replace the first stored preview image data. Stored preview image data may be deleted after a predetermined expiration period and newly generated image data may be stored. The preview image storage unit 27 stores preview image data corresponding to the number of available storage areas. The size of the preview image storage unit 27 may vary depending on the preview image size or the photographed high resolution image size.

The preview screen outputs at 10-15 frames/sec, therefore, one frame outputs every 0.067-0.1 seconds. Because the shutter lag is 0.2-0.5 seconds, image data corresponding to the frames that occur 2-7.5 frames after the shutter key is pressed can be processed into a photographed image. Therefore, there may be two to eight storage areas. According to the frame output rate and shutter lag of the photographing apparatus 10, there may be two to five storage areas when a preview screen is output at 10 frames/sec, and three to eight storage areas when a preview screen is output at 15 frames/sec.

An actual photographed image may be the preview image data acquired two frames or three frames prior to the pressing of the shutter key, because the time for pressing the shutter key and processing the corresponding signal is approximately equal to the time for outputting a preview screen of two to three frames. The control unit 11 provides preview image data of the particular storing area in a circular queue buffer for photographing image data.

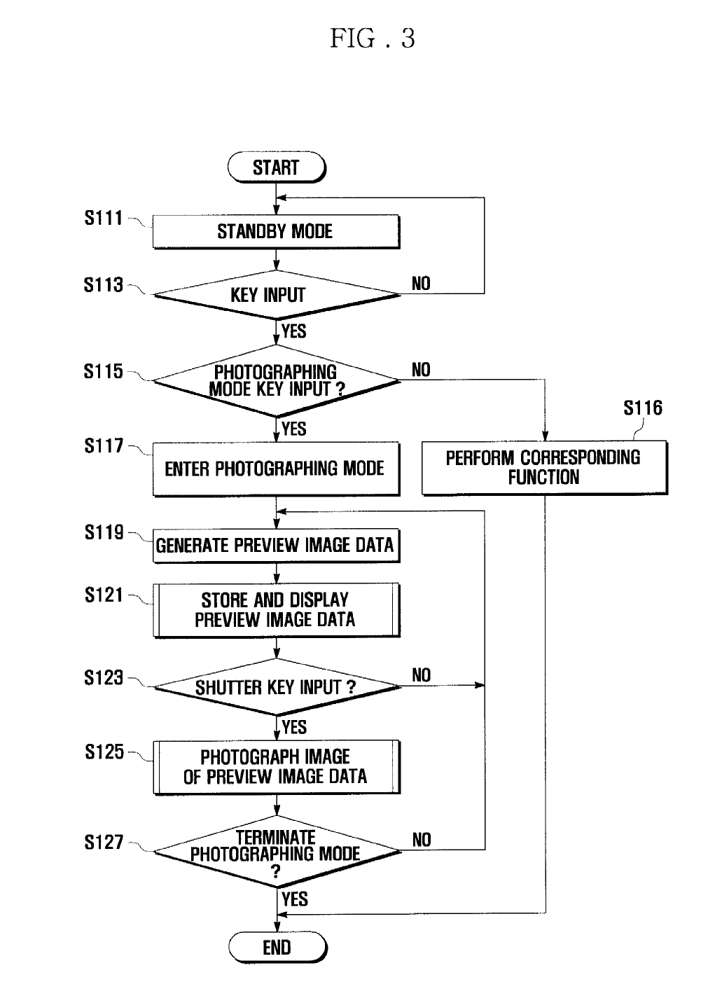

FIG. 3 is a flowchart showing a picture photographing method in accordance with an exemplary embodiment of the present invention.

First, beginning in a standby mode S111 of the photographing apparatus 10, if a key is input from the input key unit 13 by a user S113, the control unit 11 determines whether the key is input for entering a photographing mode S115. If the key is not for entering a photographing mode, the control unit 11 controls the photographing apparatus 10 to perform a corresponding function S116.

If the key is input for entering a photographing mode, the photographing apparatus enters the photographing mode S117. The control unit 11 controls the signal processing unit 19 and the image processing unit 21, activates a receiving path for an image signal output from the image sensor 17, and controls the image sensor 17 to output image signals at a status setting suitable for a preview. For example, the control unit 11 may set the image sensor 17 to output an image signal in 640×480 resolution. It is not necessary for a preview screen to have high resolution and the control unit 11 may operate effectively by outputting low resolution image signals, which may save time and/or energy.

The control unit 11 controls the signal processing unit 19 to transform an analog image signal output from the image sensor 17 into digital image data and to generate preview image data for sending to a preview screen S119.

The control unit 11 controls the image processing unit 21 to store the preview image data output from the signal processing unit 19 in the preview image storage unit 27 and to output the preview image data on the display unit 35 according to established screen data settings S121. In general, the preview screen outputs to the display unit 35 at 10-15 frames/sec. In this procedure, the preview image data is transformed into screen data by adjusting the scale of the data to meet the standard size of the display unit 35 in the size adjusting unit 23 and by changing the color of the data in the color changing unit 25, which transforms the digital image data into YUV data or RGB data.

The control unit 11 determines whether the user pressed the shutter key S123. A user can select the moment of photographing by pressing the shutter key while viewing a preview screen at the display unit 35. If a photographing signal is detected when the shutter key is pressed, the control unit 11 processes a photographed image from among the preview image data stored prior to the pressing of the shutter key in a preview image buffer S125. The image processing unit 21 reads the preview image data stored in the preview image storage unit 27 according to input of the shutter key and outputs compressed preview image data to the display unit 35 after compressing the preview image data in the image compressing unit 31. The control unit 11 stores the compressed preview image data in the storage unit 15 by entering a storing key.

The control unit 11 determines whether the user has requested termination of the photographing mode S127. If termination of the photographing mode is not requested, the control unit 11 once again generates preview screen data S119 from preview image data and outputs the preview screen to the display unit 35.

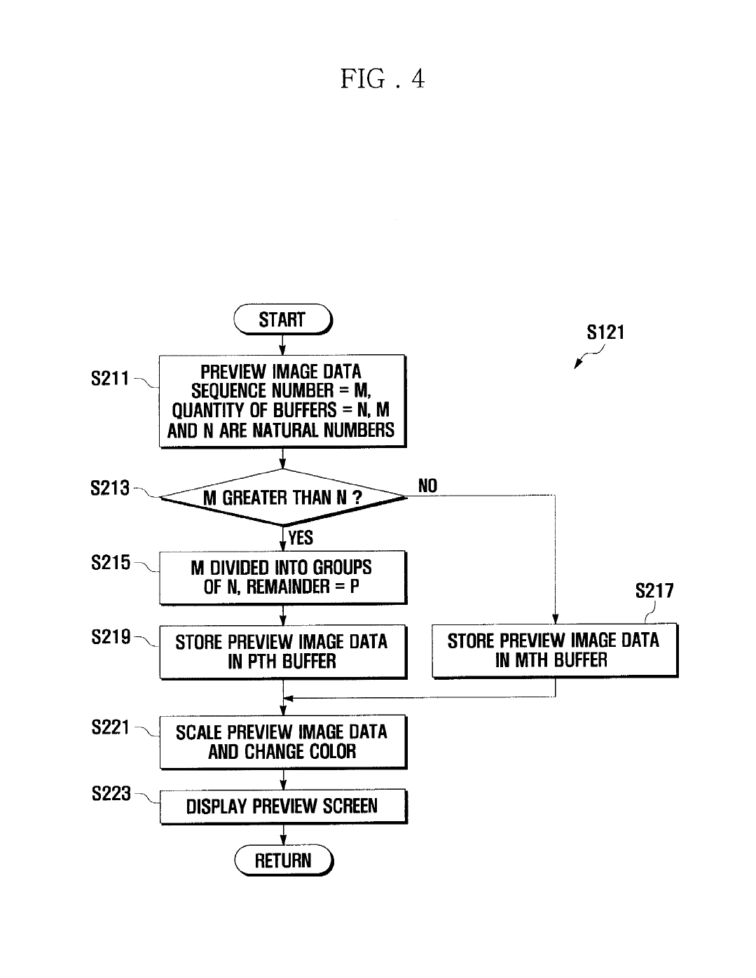

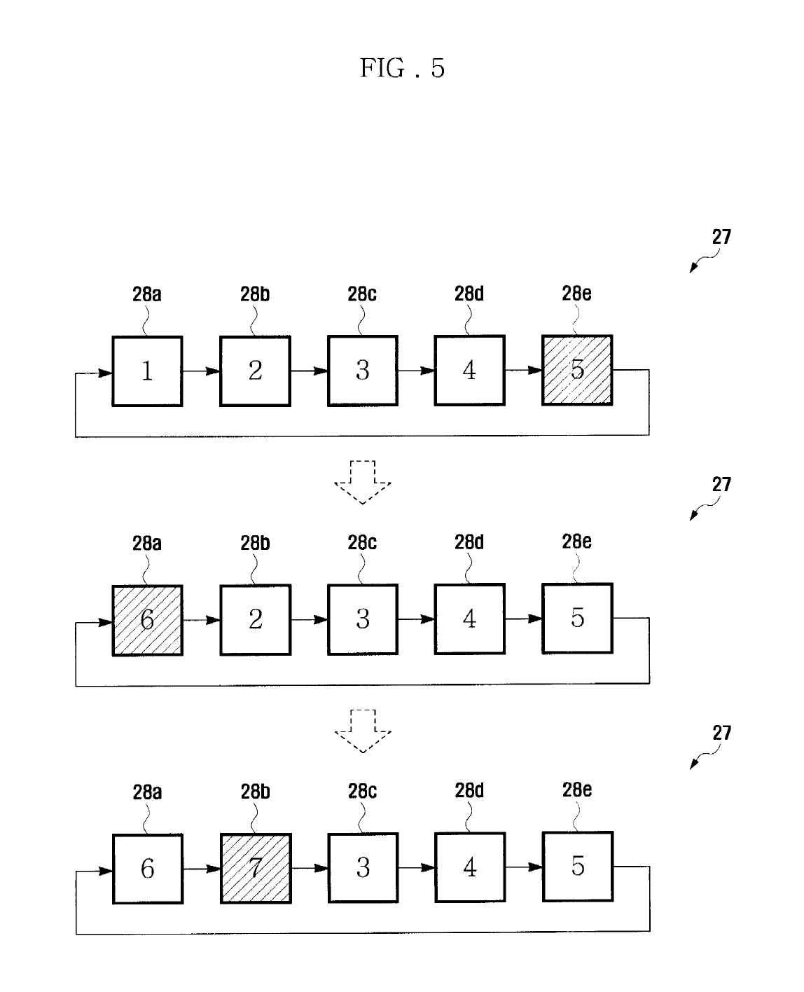

FIG. 4 is a flowchart showing a procedure for storing and displaying preview image data in the picture photographing method of FIG. 3. FIG. 5 is a diagram showing a procedure for storing a previewed image in a picture photographing method according to an exemplary embodiment of the present invention.

Referring to FIG. 4, the control unit 11 sets the sequence number of a preview image data to a natural number M, and sets the number of the preview image buffers to a natural number N S211. The control unit 11 checks whether M is greater than N S213, and, if M is not greater than N, the control unit 11 stores the preview image data into the M^{th} buffer S217. If the sequence number M of the preview image data is greater than the number of the preview image buffers N, the control unit 11 divides M into groups of size N to produce a multiple of N and a remainder P S215. The control unit 11 then stores the preview image data into the P^{th} buffer S219. For example, if the sequence number of the preview image data is 17 and the number of preview image buffers in the storage unit 15 is 5, the control unit 11 calculates 17 divided by 5 and obtains 3 with a remainder 2. The control unit 11 then stores the preview image data in the 2^{nd} preview image buffer.

When storing is complete, the control unit 11 transforms the preview image data into a preview screen by scaling and changing colors S221. The control unit 11 then outputs the preview screen to the display unit 35 S223.

Referring to FIG. 5, according to an exemplary embodiment of a method of photographing in the present invention, the preview image data may be sequentially stored in a circular queue buffer containing plural storing areas. In an example shown in FIG. 5, a circular queue buffer consists of five storing areas 28a, 28b, 28c, 28d, and 28e. Preview image data may be stored in each storing area 28a, 28b, 28c, 28d, and 28e. Five sequential pieces of preview image data are stored in five storing areas 28a, 28b, 28c, 28d, and 28e in order of occurrence, and a 6^{th} piece of preview image data is stored in storage area 28a to replace the 1^{st} piece of stored preview image data. A 7^{th} piece of preview image data replaces the 2^{nd} piece of stored preview image data in storage area 28b. As described in the above procedure, a limited amount of preview image data consisting of the most recent preview image data may be stored.

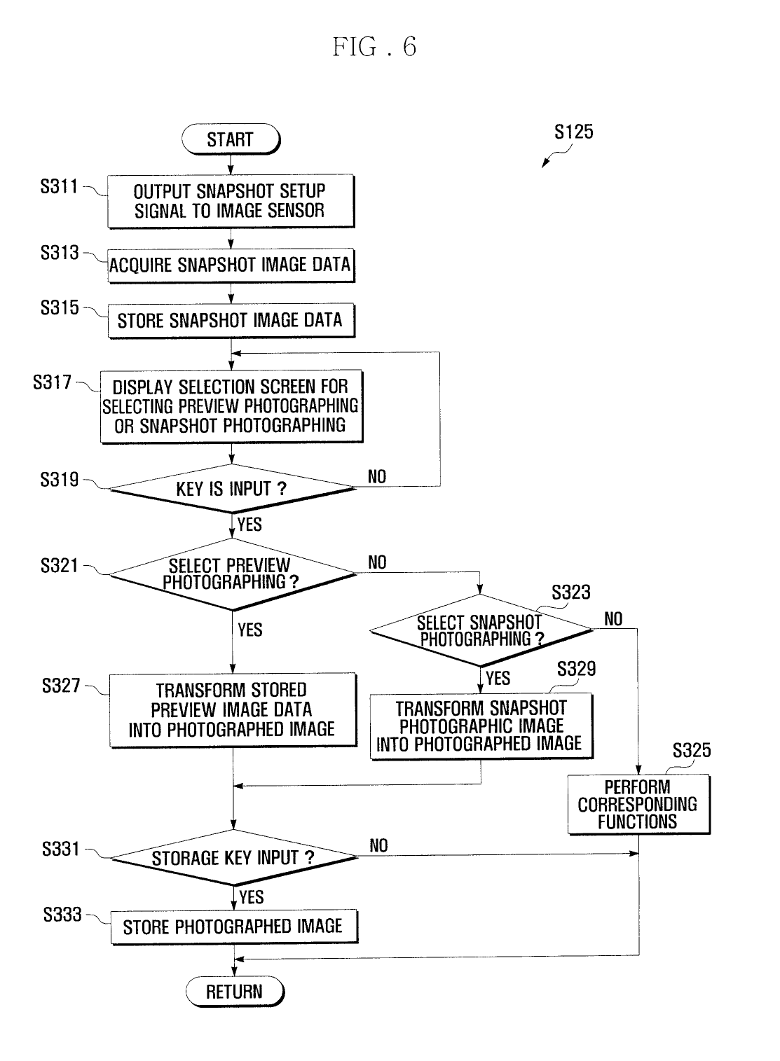

FIG. 6 is a flowchart showing an image photographing procedure in the picture photographing method of FIG. 3.

A user can select either preview photographing or snapshot photographing by performing snapshot photographing during processing of a photographed image of the preview image data.

Referring to FIG. 6, to photograph an image of the preview image data, when a shutter key is pressed, the control unit 11 outputs control signals to the image sensor 17 through the image processing unit 21 for snapshot photographing, and outputs a setting signal to control the image sensor 17 to output a high resolution image signal S311. For example, the control unit 11 may control the image sensor 17 to acquire an image signal of size 1280×960.

The control unit 11 controls the image sensor 17 to output the acquired snapshot image signal to the signal processing unit 19 to be transformed into image data S313. The transformed snapshot image data is then temporarily stored in the snapshot image storage unit 29 by the control unit 11 S315. When storing of snapshot image data is complete, the control unit 11 outputs a photographing selection screen on the display unit 35 to select either the preview photographing or the snapshot photographing of the photographing image S317. The photographing selection screen may be provided as a pop-up window. The control unit 11 determines whether a key is input in the input unit 13 during display of the photographing selection screen S319, and whether the input key is to select the preview photographing S321.

If a user selects preview photographing, the control unit 11 outputs the stored preview image data as a photographed image to the display unit 35 S327. If the user does not select preview photographing, the controller determines whether the user selects snapshot photographing S323. If the user does not select snapshot photographing, the control unit 11 performs a function corresponding to the key input S325. If the snapshot photographing is selected, the control unit 11 compresses the snapshot image data stored in the snapshot image storage unit 29 in the image compressing unit 31 and outputs the compressed snapshot image data of the photographed image to the display unit 35 S329.

Next, the control unit 11 determines whether the storing key is input S331. If the storing key is input during displaying, the control unit 11 stores the image data of the displayed photographed image as the photographed picture S333. In the case of preview photographing, the preview image data is stored as the photographed picture. In the case of snapshot photographing, the snapshot image data processed by high resolution image compression is stored as the photographed picture.

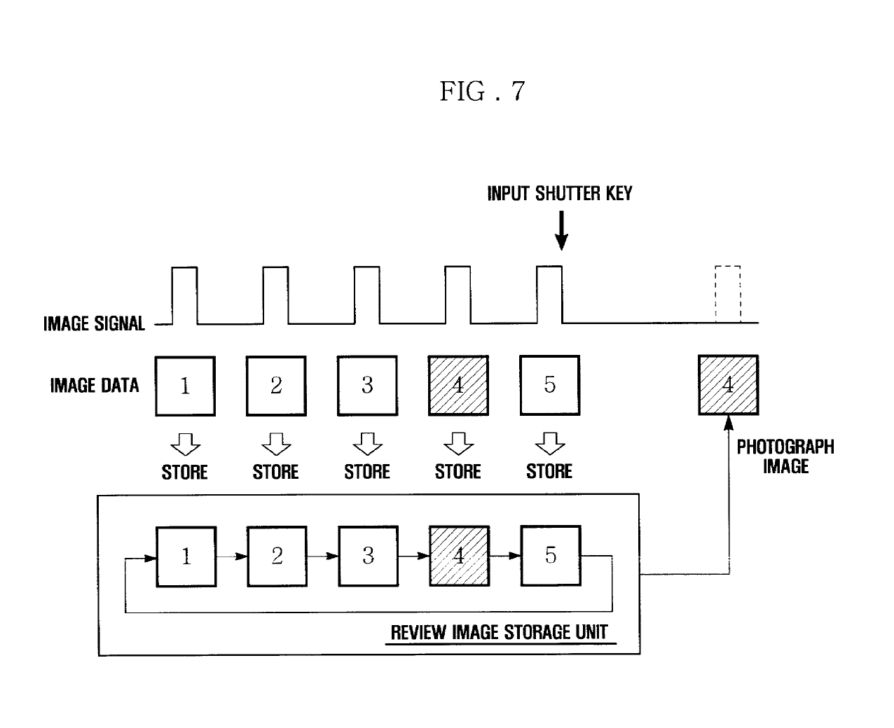

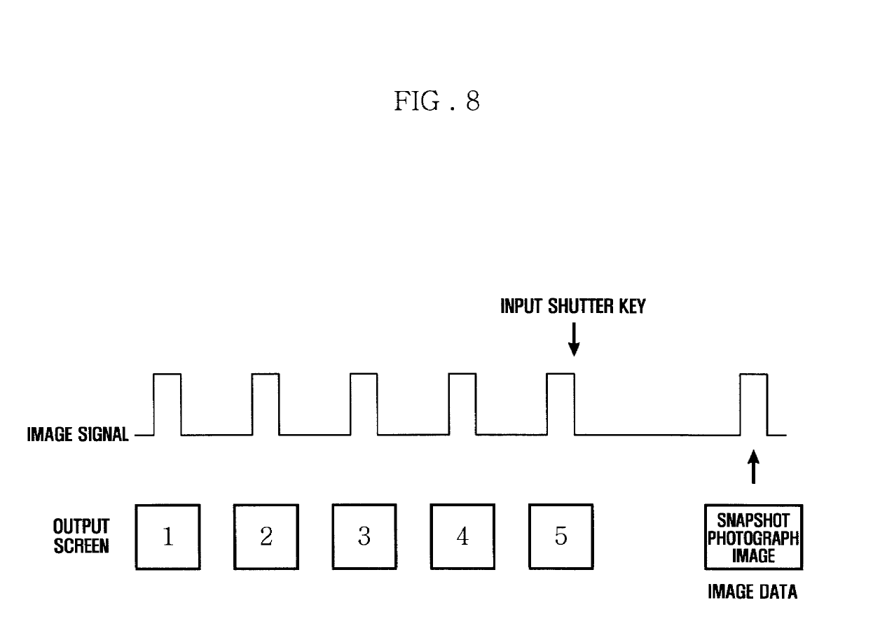

FIG. 7 and FIG. 8 are diagrams showing the image photographing procedure of FIG. 6.

For FIG. 7 and FIG. 8, it is assumed that a shutter key is pressed after the occurrence of the 5^{th} piece of preview image data. The preview image data is stored into the preview image storage unit 27 before displaying in the preview screen. The user is requested to select either preview photographing or snapshot photographing. As shown in FIG. 7, if preview photographing is selected, the control unit 11 displays the stored preview image data before the shutter key is pressed as an actual photographed image. The control unit 11 displays the stored preview image data from two frames to three frames prior to the shutter key input as the actual photographed image, in consideration of the system lag of between 0.2 seconds and 0.5 seconds from the time the shutter key is pressed. In the diagram, the 4^{th} image photographing data is displayed as the actual photographed image.

As shown in FIG. 8, if a snapshot is selected, the control unit 11 outputs the control signal to the image sensor 17 after input of the shutter key to stop output of the preview image signal from the image sensor 17, and to output a high resolution image signal for snapshot photographing. The actual photographed image is generated separately from the preview image.

As described above, in a picture photographing method according to the present invention, the control unit 11 acquires a photographed image according to a user's selection of either the stored preview image data of the preview image storage unit 27 on the display unit 35 or the stored snapshot image data of the snapshot image storage unit 29 on the display unit 35. If snapshot photographing is selected, the control unit 11 provides the high resolution snapshot photographed image as the photographed picture. If preview photographing is selected, the control unit 11 provides the actual image at the moment the shutter key is pressed as the photographed picture with a lower resolution in comparison to the high resolution snapshot.

As described above, according to the present invention, the image sensor equipped photographing apparatus and picture photographing method provide a simple and accurate photographed image of a user's desired moment by transforming a displayed preview image at the moment the shutter key is pressed into the photographed image, thereby providing a photographed image without a shutter lag.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for taking a picture with an image sensor equipped photographing apparatus, comprising:
generating image data from an image signal output by the image sensor;
storing the image data;
outputting the image data as preview image data;
receiving a photographing signal; and
photographing, upon receiving the photographing signal, an image by transforming the preview image data into a photographed image.

2. The method of claim 1, wherein the image data is stored in a circular queue buffer comprising a number of storage areas.

3. The method of claim 2, wherein storing the image data further comprises:
replacing previous image data with the current image data.

4. The method of claim 2, wherein the image data is stored in an n^{th} storage area, wherein n corresponds to the remainder after dividing a sequence number of the image data by the number of storage areas.

5. The method of claim 1, wherein the image data is stored by two frames to eight frames prior to a frame that is taken at the moment the photographing signal is received.

6. The method of claim 1, wherein outputting the image data as a preview image data further comprising:
adjusting a size of the image data and changing a color of the image data.

7. The method of claim 1, wherein the photographed image is selected from the image data taken from 2 frames to 3 frames prior to inputting the photographing signal.

8. The method of claim 1, wherein photographing an image further comprises:
acquiring snapshot image data by receiving the photographing signal;
requesting a selection of the acquired snapshot image data or the preview image data; and
transforming the selected image data into the photographed image.

9. An image sensor equipped photographing apparatus, comprising:
an image sensor to capture an image and output the image as an image signal;
a signal processing unit to process the image signal into image data;
an image processing unit to transform image data into screen data;
a display unit to display screen data;
a preview image storage unit to store the image data for display in preview image form in the display unit;
an input unit to receive a photographing signal; and
a control unit to detect the photographing signal from the input unit and control processing of the image data stored in the preview image storage unit into a photographed image.

10. The apparatus of claim 9, wherein the preview image storage unit is a circular queue buffer comprising a plurality of individual storage areas.

11. The apparatus of claim 10, wherein the circular queue buffer comprises two to eight storage areas.

12. The apparatus of claim 9, wherein the preview image storage unit receives image data from the signal processing unit connected thereto.
